(19) United States
(12) Patent Application Publication
(10) Pub. No.: US 2020/0023542 A1
(43) Pub. Date: Jan. 23, 2020

(54) MITER FENCE POSITIONER

(71) Applicant: Timothy Owens, Perrysburg, OH (US)

(72) Inventor: Timothy Owens, Perrysburg, OH (US)

(21) Appl. No.: 16/516,330

(22) Filed: Jul. 19, 2019

Related U.S. Application Data
(60) Provisional application No. 62/700,387, filed on Jul. 19, 2018.

(51) Int. Cl. B27B 27/10; B27B 27/06

(52) U.S. Cl. CPC B27B 27/10; B27B 27/06

(57) ABSTRACT

A miter saw assembly comprises a cutting tool configured to perform a cut along a cutting axis. A fence of the miter saw assembly extends longitudinally in a direction transverse to the cutting axis. A stop mechanism is linearly translatable in the longitudinal direction of the fence. A rotary motor includes a selectively rotatable rotor and a motion conversion mechanism is configured to transform rotary motion of the rotor to linear motion of the stop mechanism in the longitudinal direction of the fence. A controller is configured to selectively rotate the rotor to cause linear translation of the stop mechanism in the longitudinal direction of the fence toward or away from the cutting axis.

### CROSS-REFERENCE TO RELATED APPLICATION

This patent application claims priority to U.S. Provisional Patent Application Ser. No. 62/700,387, filed on Jul. 19, 2018, the entire disclosure of which is hereby incorporated herein by reference.

### FIELD OF THE INVENTION

The invention relates to an apparatus for repositioning a stop block of a positioning mechanism for use with a miter saw assembly.

### BACKGROUND OF THE INVENTION

A miter saw is generally used to make a cross-cut through a workpiece at a desired cut angle and position. The miter saw may include an adjustable stop surface for accurately positioning the workpiece relative to the cutting blade prior to the initiation of a cutting operation. Such stop surfaces may be manually adjusted to desired positions to establish a known distance between one end of the workpiece and the cutting axis of the miter saw. The manual adjustment may include the manipulation of one or more structural elements to reposition and lock the stop surface to the desired position.

In an effort to improve the accuracy and adjustment time for such stop surfaces, it is desirable to replace the manually adjusted system with a motor-driven system capable of automated repositioning through the use of a controller. For example, the motor-driven system may include a stop surface moveable in a longitudinal direction of the workpiece along a rail or guide structure via the transformation of the rotary motion of the motor to the translational motion of the stop surface.

However, such motor-driven systems typically include a motor and controller assembly that requires the feedback generated by an encoder or similar control device to accurately position the stop surface relative to the cutting axis. The encoder may include a sensor assembly that monitors a rotor of the motor. For example, the rotor may include circumferentially spaced features that are detectable by the sensor assembly during rotation of the rotor in a manner wherein a degree of rotation of the rotor is able to be determined by determining how many times the spaced apart features pass by the sensor assembly. The corresponding controller accordingly utilizes the number of sensed passes of the rotor to determine the degree of rotation of the rotor. The detected degree of rotation of the rotor may in turn be converted to a linear distance traversed by a stop surface operatively coupled to the monitored rotor. The associated controller may therefore be responsible for initiating the rotation of the rotor via a suitable control signal before then determining the degree of rotation of the rotor via the feedback provided by the sensor assembly of the encoder. The use of such an encoder greatly complicates the control scheme used to control the position of the stop surface, thereby adding unnecessary complexity and cost to the automated repositioning system.

Accordingly, it would be desirable to create an improved system for repositioning a stop surface of a miter saw assembly without requiring the use of an encoder or feedback producing device for communicating a condition of the motor to a controller associated therewith.

### SUMMARY OF THE INVENTION

Compatible and attuned with the present invention, an improved positioning mechanism for use with a miter saw assembly is disclosed.

In one embodiment of the invention, a positioning mechanism for positioning a workpiece relative to a cutting axis of a cutting tool is disclosed. The positioning mechanism comprises a rotary motor having a selectively rotatable rotor and a stop mechanism having a stop surface configured to engage the workpiece. The stop mechanism is linearly translatable in a first direction. A motion conversion mechanism is configured to transform rotary motion of the rotor to linear motion of the stop mechanism in the first direction. A controller is configured to selectively rotate the rotor to cause linear translation of the stop mechanism in the first direction toward or away from the cutting axis.

In another embodiment of the invention, a miter saw assembly comprises a cutting tool configured to perform a cut along a cutting axis. A fence of the miter saw assembly extends longitudinally in a direction transverse to the cutting axis. A stop mechanism is linearly translatable in the longitudinal direction of the fence. A rotary motor includes a selectively rotatable rotor and a motion conversion mechanism is configured to transform rotary motion of the rotor to linear motion of the stop mechanism in the longitudinal direction of the fence. A controller is configured to selectively rotate the rotor to cause linear translation of the stop mechanism in the longitudinal direction of the fence toward or away from the cutting axis.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings:

FIG. 1 is a top plan view of a miter saw assembly having a positioning mechanism according to an embodiment of the present invention;

FIG. 2 is a cross-sectional elevational view of a positioning system of the miter saw assembly of FIG. 1 as taken through section lines 2-2 of FIG. 1;

FIG. 3 is a top plan view of the miter saw assembly of FIG. 1 immediately prior to a cutting operation through a workpiece with a stop of the positioning system in a retracted position;

FIG. 4 is a top plan view of the miter saw assembly of FIG. 1 immediately prior to a cutting operation through a workpiece with the stop of the positioning system in a partially extended position;

FIGS. 5-7 are examples of graphical representations generated by a controller of the miter saw assembly on a display screen thereof.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

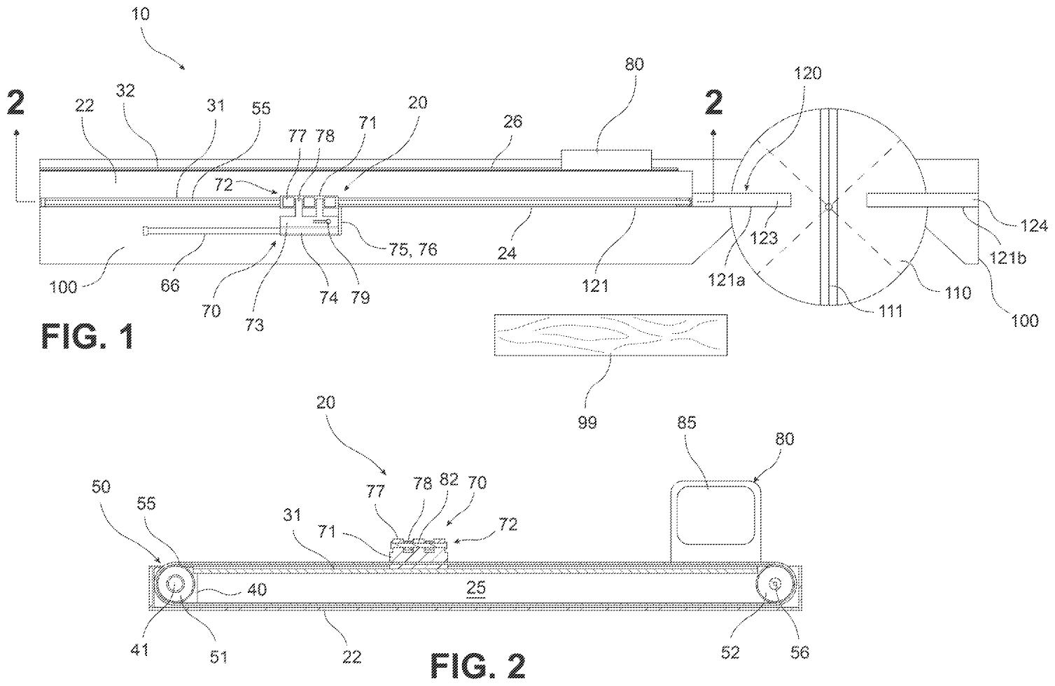

FIG. 1 illustrates a miter saw assembly 10 having a positioning mechanism 20 according to an embodiment of the invention. The miter saw assembly 10 includes a fixed table 100, a rotary table 110, a fence 120, a cutting tool (not shown) such as a miter saw, and the positioning mechanism 20. Although the positioning mechanism 20 is described with reference to a miter saw assembly 10, it should be understood that the positioning mechanism 20 may be used in conjunction with any type of cutting or machining tool where a selective positioning of a workpiece relative to a cutting axis of the cutting tool is desired without departing from the scope of the present invention.

The fixed table 100 supports the fence 120, the cutting tool, and the positioning mechanism 20. The fixed table 100 forms a horizontal and substantially planar surface for supporting a workpiece, such as a board 99 to be sawed by the cutting tool (miter saw). The fixed table 100 may be coupled to or supported by a support frame (not shown) elevating the miter saw assembly 10 away from a ground surface. The fixed table 100 may alternatively be coupled to or supported by any suitable structure, as desired.

The rotary table 110 includes an upper surface arranged co-planar to an upper surface of the fixed table 100. The rotary table 110 is configured to rotate relative to the fixed table 100 wherein a rotational position of the rotary table 110 relative to the fixed table 100 determines a rotational position of a cutting axis 111 of the cutting tool relative to the longitudinal direction of the fence 120. The cutting axis 111 may for example represent an axis along which a saw blade performs a cut through the workpiece when the corresponding blade is moved along the cutting axis 111. However, the cutting axis 111 may alternatively represent any axis through which any type of cutting tool may pass, as desired.

The cutting axis 111 may be adjusted to a plurality of different rotational positions for performing cuts through the workpiece at a plurality of different angles relative to the longitudinal direction of the fence 120. The cutting axis 111 is shown in FIG. 1 as being arranged perpendicular to the longitudinal direction of the fence 120. Alternatively, FIG. 1 shows two dashed lines representing alternative positions of the cutting axis 111 following about a 45 degree rotation of the rotary table 110 relative to the fixed table 100 in each of a clockwise direction and a counter-clockwise direction. It is understood that any number of rotational positions of the rotary table 110 and hence the cutting axis 111 may be used without departing from the scope of the present invention.

The fence 120 includes a guide surface 121 for arranging the workpiece relative to the cutting axis 111. In the provided example, the fence 120 includes a first segment 123 having a first guide surface 121a formed to a first side of the cutting axis 111 as well as a second segment 124 having a second guide surface 121b formed to an opposing second side of the cutting axis 111. The first guide surface 121a and the second guide surface 121b are arranged co-planar to each other and perpendicular to the upper surface of the fixed table 100. The guide surfaces 121a, 121b and the upper surface of the fixed table 100 accordingly form perpendicular arranged surfaces for establishing the position of two perpendicular arranged surfaces of the associated workpiece when the workpiece is pressed against the guide surface 121 while resting on the fixed table 100.

The positioning mechanism 20 includes a housing 22, a rotary motor 40, a conveyer assembly 50, and a stop mechanism 70. The housing 22 may be formed as an extrusion having a substantially constant cross-section as the housing 22 extends longitudinally from end to end, thereby simplifying formation of the housing 22. In the provided embodiment, the housing 22 is formed from a main body having a substantially constant rectangular cross-sectional shape defining a longitudinally extending central opening 25 for receiving the rotary motor 40 and portions of the conveyer assembly 50. Although described as a single opening 25, it should be understood by one skilled in the art that the housing 22 may be formed to include any number of chambers or compartments for housing the components disclosed herein without necessarily departing from the scope of the present invention.

In some embodiments, the housing 22 may be disposed on an upper surface of the first segment 123 of the fence 120 and may include a front surface 24 that is either arranged co-planar with the guide surface 121 of the fence 120 or indented rearwardly therefrom such that the housing 22 does not undesirably interfere with the placement of the board 99 or another associated workpiece relative to the fence 120. In other embodiments, the housing 22 may form a portion of the first segment 123 of the fence 120 with the front surface 24 of the housing 22 arranged co-planar with the remainder of the guide surface 121 of the fence 120 and the housing 22 supported directly on the fixed table 100, as desired.

A first rail structure 31 projects from an upper surface of the housing 22 adjacent the front surface 24 thereof while a second rail structure 32 projects from a rear surface 26 of the housing 22 formed opposite the front surface 24. In other embodiments, the second rail structure 32 may project from the upper surface of the housing 22, as desired. The first rail structure 31 and the second rail structure 32 may each include an opening (not shown) having a shape suitable for forming an interference fit with a portion of a sliding mechanism slidably disposed within the opening. For example, each of the rail structures 31, 32 may include an opening having a substantially T-shaped cross-section for receiving a substantially T-shaped structure extending from a corresponding sliding mechanism. Alternative structures for forming a mating and sliding connection may be utilized without departing from the scope of the present invention.

The conveyer assembly 50 includes a first pulley member 51, a second pulley member 52, and a belt 55. The first pulley member 51 is disposed adjacent a first end of the housing 22 opposite the cutting axis 111 and is operatively engaged to a rotor 41 of the rotary motor 40 such that rotation of the rotor 41 is directly transferred to the first pulley member 51. The second pulley member 52 is disposed adjacent an opposing second end of the housing 22 adjacent the cutting axis 111 and may be rotationally supported by an axel 56 or the like extending laterally from the housing 22. However, the position of the rotary motor 40 and the axel 56 may be reversed, as desired, without departing from the scope of the present invention. The belt 55 may be formed into a loop tensioned between the first pulley member 51 and the second pulley member 52. The belt 55 may include a plurality of teeth or similar structures (not shown) extending from an inner surface thereof while each of the pulley members 51, 52 may include corresponding teeth or similar structures (not shown) projecting from the outer surfaces thereof for mating with the teeth or similar structures of the belt 55. Accordingly, the rotational motion of the rotary motor 40 may be transferred from the rotor 41 to the remainder of the conveyer assembly 50 via the engagement of the first pulley member 51 with the belt 55 and the engagement of the belt 55 with the second pulley member 52. It should further be understood by one skilled in the art that additional pulley members may be added for re-routing or tensioning the belt 55 relative to the housing 22 without departing from the scope of the present invention so long as at least a portion of the belt 55 extends in the longitudinal direction of the fence 120 for adjusting the position of the stop mechanism 70 in the manner described hereinafter.

The rotary motor 40 may be any type of motor that does not utilize an encoder, resolver, or other sensing device for determining and communicating a rotational position of the rotor 41 thereof to the controller 80, hence the rotary motor 40 operates as an open-loop controller for controlling the position of the stop mechanism 70. In other words, the controller 80 actively controls the rotational position of the rotor 41 and hence the translational position of the stop mechanism 70 without providing feedback data to the controller 80 regarding a detected degree of rotation of the rotor 41 when the rotary motor 40 is activated to be repositioned.

Such direct motor control in the absence of feedback may be accomplished using any type of motor having stepped rotational control, such as a traditional stepper motor wherein the rotor 41 interacts magnetically with a plurality of circumferentially spaced electromagnets surrounding the rotor 41. A full rotation of the rotor 41 is accomplished via a plurality of equal and incremental rotational movements of the rotor 41 between a defined number of equally spaced rotational positions. A portion of an outer circumferential surface of the rotor 41 may be first electromagnetically attracted to an electrically energized one of the circumferentially spaced electromagnets as determined by the controller 80 to establish an initial rotational position of the rotor 41. Each time the rotational position of the rotor 41 is to be changed, the controller 80 sends a signal indicating that one of the electromagnets disposed adjacent the energized one of the electromagnets is to be selectively energized following a de-energizing of the previously energized electromagnet. The rotor 41 in turn moves from one rotational position to the adjacent rotational position while passing through a defined angle of rotation. This process may be repeated to cause continued rotation of the rotor 41 in a given rotational direction or may be reversed to cause the rotor 41 to change rotational directions. As used hereinafter, the process of repositioning the rotor 41 between adjacent rotational positions is referred to as “pulsing” the rotary motor 40 due to the manner in which the traditional stepper motor utilizes a series of input pulses (typically square wave pulses) for controlling the rotational position of the rotor 41.

The stepper motor forming the rotary motor 40 may be configured to move through any suitable incremental angle of rotation when pulsed so long as an integer number of incremental rotational steps provides for one full rotation of the rotor 41. For example, the rotary motor 40 may be configured to include 100 incrementally stepped positions with each of the positions separated from an adjacent position by 3.6 degrees, 200 incrementally stepped positions separated by 1.8 degrees, 400 incrementally stepped positions separated by 0.9 degrees, and so on. However, the rotary motor 40 may be selected to include any desired number of suitable rotational positions without necessarily departing from the scope of the present invention. The degree of linear translation of the slider mechanism 70 in response to each incremental repositioning of the rotor 41 may be determined by selecting a ratio of the diameter of the rotor 41 to a diameter of the first pulley member 51, as desired.

The stop mechanism 70 includes a slider 71, a hinge assembly 72, at least one rotatable arm 73, a shaft guide 74, and a stop 75. The slider 71 slidably engages the first rail structure 31 and includes corresponding structure (not shown) for forming an interference fit within the opening formed by the first rail structure 31. For example, the slider 71 may include a substantially T-shaped projection (not shown) depending from an underside of the slider 71 and disposed within the T-shaped opening of the first rail structure 31. However, any suitable mating structure for forming the sliding connection between the slider 71 and the first rail structure 31 may be utilized without departing from the scope of the present invention. The slider 71 is rigidly coupled to an upper portion of the belt 55 extending over the first rail structure 31 in a manner wherein translation of the upper portion of the belt 55 in the longitudinal direction of the fence 120 causes a sliding of the slider 71 within the first rail structure 31. However, in some embodiments the belt 55 may be disposed entirely within the opening 25 and the portion of the housing 22 defining the first rail structure 31 may include a longitudinally extending slot or opening (not shown) through which structure connecting the belt 55 and the slider 71 may be disposed, as desired.

The slider 71 may be rigidly coupled to opposing ends of a strip of material forming the belt 55 to allow for easy installation of the belt 55 over the opposing pulley members 51, 52 before the coupling of the slider 71 thereto. The slider 71 accordingly forms a portion of the belt 55 that is restricted to move linearly within the first rail structure 31 in a direction parallel to the longitudinal direction of the fence 120 and the longitudinal direction of the housing 22.

The shaft guide 74 is disposed at an end of the at least one rotatable arm 73. The stop 75 includes a stop surface 76 disposed at an end of a shaft 66 telescopically received within the shaft guide 74. The stop 75 is configured to telescope relative to the shaft guide 74 to selectively adjust a position of the stop 75 relative to the slider 71 with respect to the longitudinal direction of the fence 120. A locking device 79 may be used to affix an axial position of the shaft 66 within the shaft guide 74. The locking device 79 may be configured wherein the shaft 66 may only be affixed to the shaft guide 74 at predetermined positions to maintain a known distance between the stop surface 76 and the slider 71. For example, the shaft guide 74 and the shaft 66 may include spaced apart openings that can be aligned with each other in order to receive a locking device such as a pin or the like. The different positions may be spaced at equal intervals corresponding to common distances utilized during use of the miter saw assembly 10, such as increments equaling an inch or common fractions of an inch, as desired. However, one skilled in the art will appreciate that alternative locking devices and spacing intervals may be utilized without departing from the scope of the present invention.

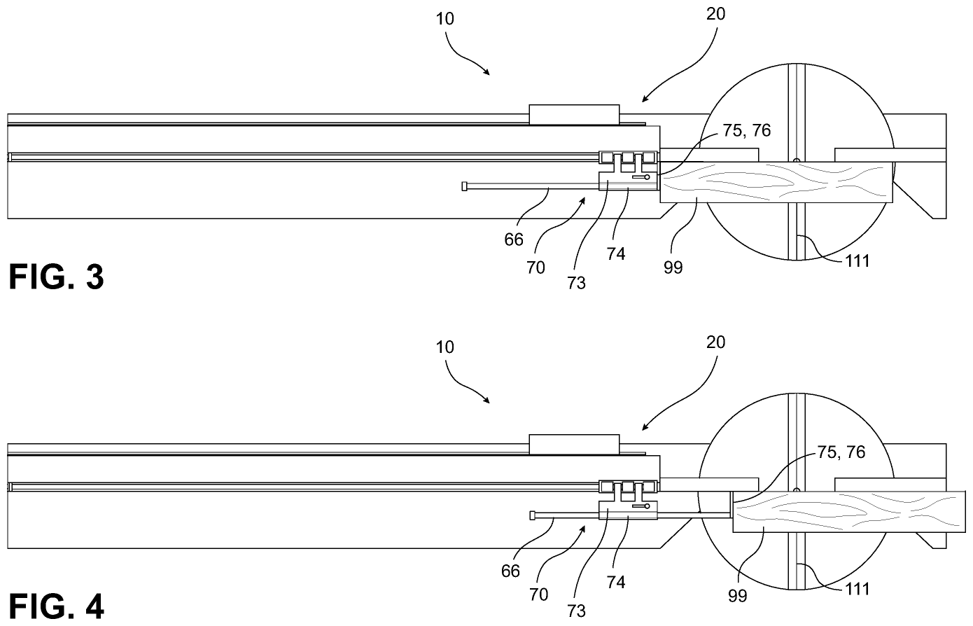

As shown by comparison between FIGS. 3 and 4, the stop 75 may be moved in the longitudinal direction of the fence 120 towards the cutting axis 111 via the telescoping of the shaft 66 within the shaft guide 74 in order to perform cuts at desired locations relative to the workpiece (board) 99. Such telescoping of the shaft 66 may occur in circumstances wherein a particularly small distance is required between the end of the workpiece engaging the stop 75 and the cutting axis 111. The telescoping stop 75 is accordingly able to be adjusted to positions beyond the engagement between the slider 71 and the first rail structure 31 for arranging the end of the workpiece more closely to the cutting axis 111 as illustrated in FIG. 4.

The hinge assembly 72 includes a first set of knuckles 77 secured to the slider 71 and a second set of knuckles 78 secured to the at least one rotatable arm 73. A hinge pin 82 extends through openings formed in the knuckles 77, 78 to hingedly couple the at least one rotatable arm 73 to the slider 71. The hinge assembly 72 may include a locking device (not shown) for affixing a position of the stop 75 in one of a stopping position wherein the stop surface 76 is adjacent the fixed table 100 and the guide surface 121 for engaging the workpiece and a retracted position wherein the stop surface 76 is rotated away from the fixed table 100 and the workpiece via rotation of the rotatable arm 73 such that the stop surface 76 does not interfere with or contact the workpiece. The at least one rotatable arm 73 is shown as a single arm pivotally coupled to the slider 71 in FIG. 1, but the at least one rotatable arm 73 may alternatively be presented as a compound element having one or more additional joints for further collapsing the stop mechanism 70 when moved to the retracted position. The stop mechanism 70 may also include alternative structure for selectively retracting the stop 75, such as a rail structure or the like for sliding the stop 75 vertically away from the fixed table 100, as desired.

The positioning mechanism 20 further includes a controller 80 prominently displayed to an operator of the miter saw assembly 10. The controller 80 may include cooperating structure configured to engage the second rail structure 32 of the housing 22 to allow the controller 80 to be repositioned relative to the longitudinal direction of the housing 22 for ease of access during use of the miter saw assembly 10. A locking mechanism (not shown) may be used to removably affix a position of the controller 80 relative to the longitudinal direction of the housing 22, as desired. In other embodiments, the controller 80 may be permanently affixed in position relative to the housing 22, as desired.

The controller 80 includes the necessary structure for sending and receiving control signals, performing logical operations regarding the control signals, and displaying information to the operator of the miter saw assembly 10. The controller 80 accordingly includes a suitable memory, processor, and any associated instruction sets for carrying out the tasks assigned to the controller 80. The controller 80 is in signal communication with a motor controller (not shown) of the rotary motor 40, and the controller 80 and the rotary motor 40 may each be in electrical communication with a common power source (not shown), as desired.

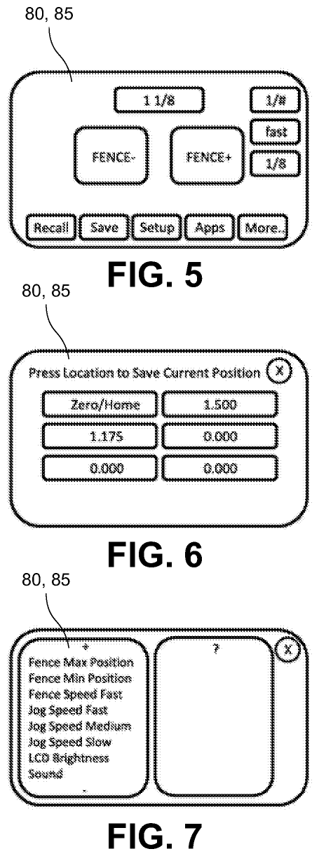

Referring to FIG. 5, an exemplary touchscreen display 85 for controlling the position of the stop mechanism 70 with respect to the longitudinal direction of the fence 120 is disclosed. The display 85 may include a position readout that illustrates the current position of the slider 71 (and hence the stop 75) in terms of a numeric distance value relative to a zero/home position corresponding to a numeric distance value of zero. The corresponding units of distance may be displayed in one or more of English units, Metric units, and fractions thereof. For example, the display 85 shows a current position of “1⅛” in a top central portion of the display 85 indicative of the stop mechanism 70 being displaced 1⅛ inch from the previously established zero/home position for the stop mechanism 70. The display 85 further illustrates a “fence−” key and a “fence+” key, wherein the “fence−” key is used to pulse and reposition the slider mechanism 70 one incremental position to the left (negative direction with respect to the displayed numeric value) and the “fence+” key is used to pulse and reposition the slider mechanism 70 one incremental position to the right (positive direction with respect to the displayed numeric value). Either key may be held to cause the rotary motor 40 to be pulsed periodically to cause repeated incremental movement of the slider mechanism 70 in the selected direction of translation. The controller 80 is configured to constantly update the illustrated numeric position data shown on the display 85 in accordance with the number of pulses of the rotor 41 in either rotational direction as counted by the controller 80.

The display 85 also illustrates keys for adjusting the distance the slider mechanism 70 moves in response to each press of one of the “fence−” key or the “fence+” key, such as the illustrated distance of ⅛ inch. The available increments of distance may be selected to be multiples of the distance the slider mechanism 70 travels in the longitudinal direction of the fence 120 when the rotary motor 40 repositions the rotor 41 thereof one incremental rotational position. For example, if the rotary motor 40 is incremented such that the smallest possible rotation of the rotor 41 when stepped to the next position corresponds to 1/32 of an inch, then the available increments may be multiples of 1/32, such as 1/16, ⅛, ¼, ½, etc. The display 85 further indicates a speed setting, wherein the speed setting may be used to determine how quickly the rotor 41 is pulsed between adjacent incremental positions.

Referring to FIG. 6, the memory of the controller 80 includes functionality for saving current positions and recalling previously stored positions. Exemplary positions may include ‘zero/home’ and various other positions that may be user-set memory positions. The controller 80 may also allow for direct entry of positional information, as desired.

Referring to FIG. 7, the display 85 of the controller 80 may include a screen for setup and the selection of various operational settings. The system setup screen allows the user to adjust system parameters and preferences. Exemplary parameters are shown in the left-hand side of the screen. The right-hand side of the screen may be reserved for editing the selected parameter. Once a parameter is selected, a graphical image may visually display the depicted item. The controller 80 may further include a USB port or like port for downloading and uploading data to the controller 80, as desired.

The controller 80 is configured to selectively rotate the rotor 41 of the rotary motor 40 to in turn translate the belt 55 and hence the slider 71 relative to the fence 120. The controller 80 may be a conventional Programmable Logic Controller (PLC) known to those skilled in the art. The PLC may receive outputs from a touchscreen panel forming the display 85 and may in turn send control signals to the rotary motor 40, which in turn controls the rotor 41 thereof. The controller 80 may include a Dynamic Link Library (DLL) that stores stop positions and cutter configurations in memory for later use. Stop positions may be set by the user or set automatically when a certain cutter configuration is used. The system may further include a touch-off plate known to those skilled in the art for zeroing the device between stop position adjustments.

In use, an operator of the miter saw assembly 10 sets a rotational position of the cutting axis 111 as desired for the given application of the cutting tool. The operator then determines a desired position for the workpiece 99 relative to the cutting axis 111 for performing the desired cutting operation. The operator then controls a position of the slider 71 relative to the longitudinal direction of the housing 22 through use of the touch screen display 85 of the controller 80 to set a position of the stop surface 76 of the stop mechanism 70. As explained herein, the operator may choose to jog the slider 71 to a specified position by interacting with the touch screen display 85 (such as pressing and holding indicia indicating a specific direction of travel) or the controller 80 may be preprogrammed to move the slider 71 to a specific position based on a selection of the operator. Movement of the slider 71 in a first translational direction includes a rotation of the rotor 41 in a first rotational direction while translation of the slider 71 in an opposing second translational direction includes a rotation of the rotor 41 in a second opposing rotational direction. The rotation of the rotor 41 causes the rotation of the first pulley member 51 which in turn causes a portion of the belt 55 coupled to the slider 70 to translate in a longitudinal direction of the housing 22. The controller 80 controls the rotation of the rotor 41 without requiring the feedback from an encoder associated with the rotary motor 40 and the controller 80 due to the manner in which the controller 80 actively pulses the rotor 41 to new rotational positions without monitoring the rotation of the rotor 41.

The operator may also set a position of the stop surface 76 relative to the slider 71 by telescoping the shaft 66 to a desired position relative to the shaft guide 74 such that a known relationship (distance) exists between a position of the stop surface 76 and a position of the slider 71 as set by the controller 80. The stop surface 76 may be secured by adjusting the locking device 79 when the shaft 66 is telescoped to the desired position. Once the position of the stop surface 76 is established, the operator may then place the workpiece 99 in abutting contact with the stop surface 76 and one or more of the front surface of the housing 22 and the fence 120. The workpiece 99 is then in a position for a desired cutting operation to take place through use of the corresponding cutting tool.

The disclosed positioning system 20 provides numerous advantages over the positioning systems of the prior art. The use of the stepper motor having pulsed and incremental control allows for precise and repeatable positioning of the stop mechanism 70 relative to the associated cutting axis 111. The incremental control is also achieved without the use of an encoder, resolver, or similar sensing device for providing feedback, thereby resulting in reduced cost and complexity in manufacturing the repositioning system 20. The stop mechanism 70 includes a stop surface 76 that is beneficially translatable relative to the remainder of the stop mechanism 70 for performing cuts adjacent an end of an associated workpiece. The stop mechanism 70 is also adjustable between a retracted position and a stop position to allow for the selective use of the stop mechanism 70 depending on the given application.

Although the positioning system 20 has been shown and described with regards to a conveyer assembly, it should be appreciated by one skilled in the art that any variety of additional motion conversion mechanisms configured to convert the rotary motion of the rotor 41 to the linear motion of the stop mechanism 70 may be utilized without necessarily departing from the scope of the present invention. For example, the conveyer assembly may be replaced with a linear screw drive system (not shown) wherein a screw driven by the rotary motor 40 causes the linear translation of a guided nut formed by the stop mechanism 70. Alternatively, the stop mechanism 70 may include the rotary motor 40 coupled thereto for rotating wheels or rollers (not shown) rotatably coupled to the stop mechanism 70 relative to a guide surface extending in the direction of travel of the stop mechanism 70. In either circumstance, the associated system includes a known conversion of the rotary motion of the associated rotor into the linear motion of the associated stop mechanism 70 such that the controller 80 may suitably determine the numerical position of the stop mechanism 70 relative to a selected zero/home position. Furthermore, although not shown or described herein, it should also be apparent to one skilled in the art that additional rotary motion mechanisms may be disposed between the associated rotor and the associated stop mechanism for further controlling the conversion of the rotary power to the linear motion, such as a suitable gear box, pulley system, or the like.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A positioning mechanism for positioning a workpiece relative to a cutting axis of a cutting tool, the positioning mechanism comprising:
a rotary motor having a selectively rotatable rotor;
a stop mechanism having a stop surface configured to engage the workpiece, the stop mechanism linearly translatable in a first direction;
a motion conversion mechanism configured to transform rotary motion of the rotor to linear motion of the stop mechanism in the first direction; and
a controller configured to selectively rotate the rotor to cause linear translation of the stop mechanism in the first direction toward or away from the cutting axis.

2. The positioning mechanism of claim 1, wherein the rotary motor is a stepper motor.

3. The positioning mechanism of claim 2, wherein the rotor is rotatable to a finite number of rotational positions with the rotational positions equally angularly spaced apart.

4. The positioning mechanism of claim 3, wherein the selective rotating of the rotor by the controller includes pulsing the rotor of the rotary motor to an adjacent rotational position of the finite number of rotational positions.

5. The positioning mechanism of claim 1, wherein the controller and the rotary motor are not associated with an encoder for providing feedback regarding rotation of the rotor.

6. The positioning mechanism of claim 1, wherein the motion conversion mechanism is a conveyer assembly.

7. The positioning mechanism of claim 6, wherein the conveyer assembly includes a first pulley member, a second pulley member, and a belt tensioned over the first pulley member and the second pulley member.

8. The positioning mechanism of claim 7, wherein the first pulley member is coupled to the rotor of the rotary motor and rotates in unison therewith and the stop mechanism is coupled to the belt and translates in unison therewith.

9. The positioning mechanism of claim 8, wherein the stop mechanism slidably engages a rail structure extending in the first direction.

10. The positioning mechanism of claim 1, wherein the motion conversion mechanism is one of a linear screw drive or a roller assembly.

11. The positioning mechanism of claim 1, wherein the stop surface is coupled to a shaft configured to telescope in the first direction.

12. The positioning mechanism of claim 11, wherein a locking device affixes a position of the shaft in the first direction.

13. The positioning mechanism of claim 1, wherein the stop mechanism is rotatable between a stopping position for engaging the workpiece and a retracted position for not engaging the workpiece.

14. The positioning mechanism of claim 1, wherein the rotary motor and the motion conversion mechanism are disposed in a housing of the positioning system.

15. The positioning mechanism of claim 14, wherein the stop mechanism includes a slider slidably coupled to a rail structure of the housing, the rail structure extending longitudinally in the first direction.

16. The positioning mechanism of claim 1, further comprising a fence having a guide surface extending longitudinally in the first direction.

17. The positioning mechanism of claim 1, wherein the cutting axis extends in a direction transverse to the first direction.

18. The positioning mechanism of claim 1, wherein the controller is configured to display numeric data regarding the position of the stop surface relative to the cutting axis.

19. The positioning mechanism of claim 1, wherein the controller is configured to store preselected positions of the stop surface relative to the cutting axis.

20. A miter saw assembly comprising:
a cutting tool configured to perform a cut along a cutting axis;
a fence extending in a longitudinal direction transverse to the cutting axis;
a rotary motor having a selectively rotatable rotor;
a stop mechanism having a stop surface, the stop mechanism linearly translatable in the longitudinal direction of the fence;
a motion conversion mechanism configured to transform rotary motion of the rotor to linear motion of the stop mechanism in the longitudinal direction of the fence; and
a controller configured to selectively rotate the rotor to cause linear translation of the stop mechanism in the longitudinal direction of the fence toward or away from the cutting axis.
